(19) United States
(12) Patent Application Publication
(10) Pub. No.: US 2011/0197134 A1
(43) Pub. Date: Aug. 11, 2011

(54) METHODS, APPARATUSES AND COMPUTER PROGRAM PRODUCTS FOR SETTING THE MOST PLAYED ITEMS OF MEDIA DATA AS RINGTONE ALERTS

(75) Inventor: Janne Mikael Kulmala, Littoinen (FI)

(73) Assignee: Nokia Corporation

(21) Appl. No.: 12/704,132

(22) Filed: Feb. 11, 2010

(51) Int. Cl. G06F 15/177

(52) U.S. Cl. 715/736

(57) ABSTRACT

An apparatus for assigning items of media content as ringtones corresponding to a contact(s) or group(s) of contacts is provided. The apparatus may include a processor and a memory storing executable computer program code that causes the apparatus to at least perform operations including determining an item(s) of media content, among a plurality of items of media content, that was played by the apparatus a highest number of times during a predetermined time period and assigning the item of media content as a ringtone associated with a contact(s) that has communicated with the apparatus. The computer program code may further cause the apparatus to play the data associated with the item of media content in response to receipt of a communication from the contact. Corresponding computer program products and methods are also provided.

### TECHNOLOGICAL FIELD

Embodiments of the invention relate generally to mechanisms for assigning the most often played media data as a ringtone for a device and more particularly relate to a method, apparatus and computer program product for assigning a most played item of media data as a ringtone(s) for one or more contacts or one or more groups of contacts.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer and convenience to users relates to provision of ringtones and alerts for notifying a user of an incoming call or message.

Currently, users typically personalize ringtones by manually assigning audible data (e.g., songs) to particular contacts in a phonebook of a communication device. However, manually assigning audible data as a ringtone for one or more users in a phonebook may be a tedious and time consuming task which may result in user dissatisfaction. On the other hand, it may be very desirable and beneficial for the user of the communication device to be able to identify a contact that is calling or sending the user a message on the basis of a distinctive ringtone, particularly in crowded environments or in situations in which the user may not be able to view a display of a communication device to identify the originator of the call or message.

In view of the foregoing drawbacks, it may be beneficial to provide a mechanism for improving the generation of ringtones and assigning these ringtones to one or more contacts or groups of contacts.

### BRIEF SUMMARY

A method, apparatus and computer program product are therefore provided that may assign items of media data/content of a device as ringtones associated with one or more contacts as well as one or more groups of contacts in user-friendly and efficient manner.

In this regard, the exemplary embodiments may determine the number of times items of media data (e.g., songs, video data, etc.) are played by a device and may determine the number of times one or more contacts or one or more groups of contacts communicate with a device, for example by calling or sending the device a message. Based on the number of times items of media data are played by the device and/or the number of times a contact(s) or group(s) communicates with the device during a given or predetermined time period, the exemplary embodiments may automatically assign respective items of the media content as ringtones associated with corresponding contacts or groups.

For example, in response to determining an item of media data that is most often played by the device and a contact that communicated with the device the most during the predetermined time period, the exemplary embodiments may automatically assign the most played item of media data (e.g., a song) as a ringtone associated with the contact (e.g., a user's Mother). In this regard, when the respective contact communicates with the device, the exemplary embodiments may play the item of media data to indicate receipt of the incoming communication (e.g., a call or message).

In one exemplary embodiment, a method for assigning items of media content as ringtones corresponding to a contact(s) or group(s) of contacts is provided. The method may include determining at least one item of media content that was played by a device a highest number of times during a predetermined time period. The method may also include assigning the item of media content as a ringtone associated with at least one contact that has communicated with the device and causing the data associated with the item of media content to be played in response to receipt of at least one communication from the contact.

In another exemplary embodiment, an apparatus for assigning items of media content as ringtones corresponding to a contact(s) or group(s) of contacts is provided. The apparatus may include at least one processor and at least one memory storing computer program code configured to, with the at least one processor, cause the apparatus to determine at least one item of media content that was played by a device a highest number of times during a predetermined time period. The memory and the computer program code are further configured to, with the processor, cause the apparatus to assign the item of media content as a ringtone associated with at least one contact that has communicated with the device and cause the data associated with the item of media content to be played in response to receipt of at least one communication from the contact.

In another exemplary embodiment, a computer program product for assigning items of media content as ringtones corresponding to a contact(s) or group(s) of contacts is provided. The computer program product may include at least one computer-readable storage medium having computer-executable program code instructions stored therein. The computer-executable program code instructions may include program code instructions for determining at least one item of media content that was played by a device a highest number of times during a predetermined time period. The computer-executable program code instructions may also include program code instructions for assigning the item of media content as a ringtone associated with at least one contact that has communicated with the device and causing the data associated with the item of media content to be played in response to receipt of at least one communication from the contact.

Embodiments of the invention facilitate ease and efficiency in assigning items of media data as ringtones. As such, mobile terminal users may enjoy improved mobile device functionality with respect to assigning ringtones to one or more contacts as well as one or more groups of contacts.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is a schematic block diagram of a system according to an exemplary embodiment of the invention;

FIG. 2 is a schematic block diagram of an apparatus for assigning one or more items of media data as ringtones for one or more contacts or groups according to an exemplary embodiment of the invention;

FIG. 3 is a diagram of a user setting according to an exemplary embodiment of the invention;

FIG. 4 is a diagram of lists of items of media data that may be assigned as ringtones for one or more contacts or groups according to an exemplary embodiment of the invention;

FIG. 5 is a diagram of a contact list according to an exemplary embodiment of the invention; and

FIGS. 6A & 6B are flowcharts according to an exemplary method for assigning items of media data as ringtones for one or more contacts or groups according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As used herein, ‘items of media data’ or ‘items of media content’ may used interchangeably to refer to any data that may be associated with audio data and may include, but is not limited to, one or more songs, melodies, ring tunes, images, photographs and animations associated with audio data as well as video data (e.g., movies, music videos, video clips) and any other suitable data. Additionally, as referred to herein a ‘communication’ may, but need not, denote an initial receipt of a request to communicate with a device, even though the data (e.g., voice data in the case of a call) associated with the request may not yet be received. Moreover, as used herein the term ‘contact’ or ‘contacts’ may refer to one or more persons or one or more devices by which the persons communicate.

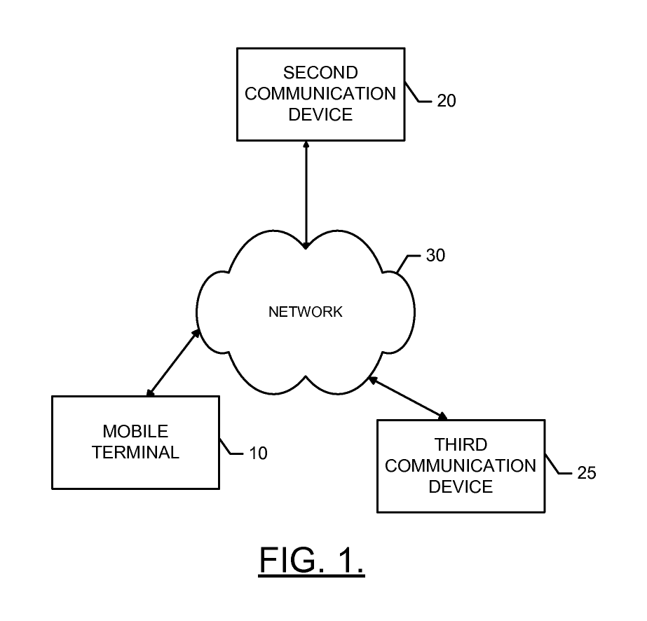

FIG. 1 illustrates a generic system diagram in which a device such as a mobile terminal 10 is shown in an exemplary communication environment. As shown in FIG. 1, an embodiment of a system in accordance with an example embodiment of the invention may include a first communication device (e.g., mobile terminal 10) and a second communication device 20 capable of communication with each other via a network 30. In some cases, embodiments of the present invention may further include one or more additional communication devices, one of which is depicted in FIG. 1 as a third communication device 25. In some embodiments, not all systems that employ embodiments of the present invention may comprise all the devices illustrated and/or described herein. While several embodiments of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices or any combination of the aforementioned, and other types of voice and text communications systems, can readily employ embodiments of the present invention. Furthermore, devices that are not mobile, such as servers and personal computers may also readily employ embodiments of the present invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like. In some embodiments, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In example embodiments, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as personal computers (PCs) or laptop computers.

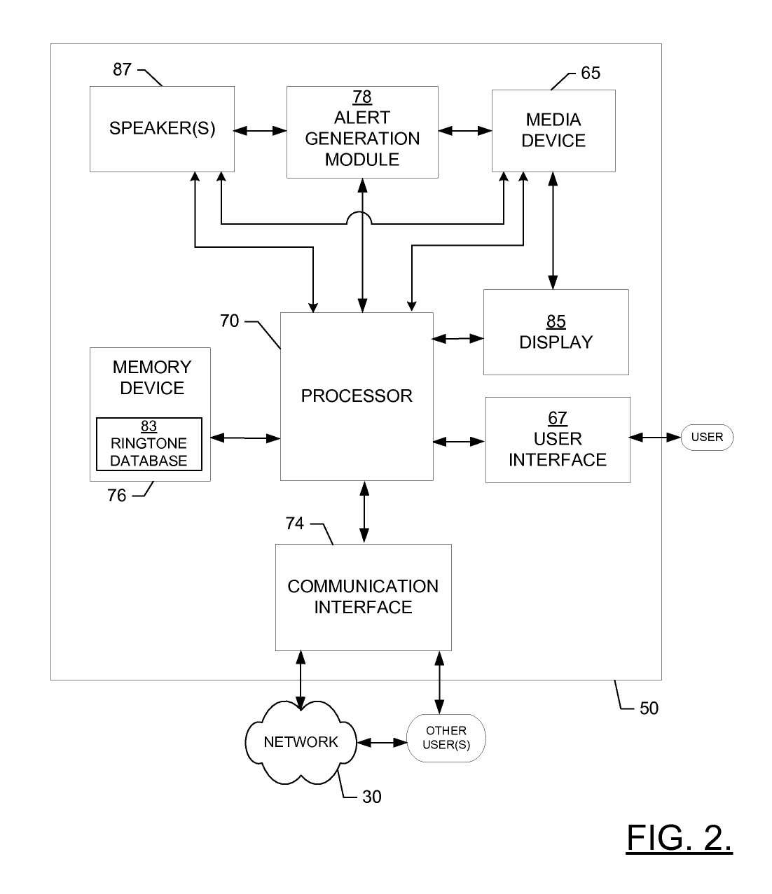

In an exemplary embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities. In an exemplary embodiment, one or more of the devices in communication with the network 30 may employ an alert generation module (e.g., alert generation module 78 of FIG. 2). The alert generation module may assign the most played media data such as for example a song, ring tune, video (e.g., music video), etc. as a ringtone for a contact(s) or a group(s) of contacts. In an exemplary embodiment, the alert generation module may assign the most played media data as a ringtone for a contact(s) or group(s) of contacts that calls or sends a user a message a most or highest number of times.

In an exemplary embodiment, the mobile terminal 10 and the second and third communication devices 20 and 25 may be configured to include the alert generation module. However, in other alternative embodiments the mobile terminal 10 may include the alert generation module and the second and third communication devices 20 and 25 may be network entities such as servers or the like that are configured to communicate with the mobile terminal 10.

In an exemplary embodiment, the mobile terminal as well as the second and third communication devices 20 and 25 may employ an apparatus (e.g., apparatus of FIG. 2) capable of employing embodiments of the invention.

FIG. 2 illustrates a schematic block diagram of an apparatus for assigning items of media data as ringtones for one or more contacts or one or more groups of contacts according to an exemplary embodiment of the invention. An exemplary embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, embodiments may be employed on a combination of devices. Accordingly, some embodiments of the present invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in certain embodiments.

Referring now to FIG. 2, an apparatus for assigning media data as a ringtone for one or more contacts or one or more groups of contacts is provided. The apparatus 50 may include or otherwise be in communication with a processor 70, a user interface 67, speakers 87, a media player 65, a communication interface 74, a memory device 76 (also referred to herein as memory), a display 85, and an alert generation module 78.

The memory device 76 may include, for example, volatile and/or non-volatile memory. The memory device 76 may be configured to store information, data (e.g., audio and video data), applications, instructions or the like for enabling the apparatus to carry out various functions in accordance with exemplary embodiments of the invention. It should be pointed out that the memory device 76 could be configured to buffer input data for processing by the processor 70. Additionally or alternatively, the memory device 76 could be configured to store instructions for execution by the processor 70. As yet another alternative, the memory device 76 may be, or may include, one of a plurality of databases that store information and/or media content (e.g., one or more songs, ring tunes, video data (e.g., movies, music videos, video clips), images, photographs, animations, etc.). In this regard, the memory 76 may include a ringtone database 83 which may store media content (also referred to herein as media data) that may be used as a ringtone to alert a user of an incoming call or message (e.g., text or short message service (SMS) message, multimedia messaging service (MMS) message, email message, etc.).

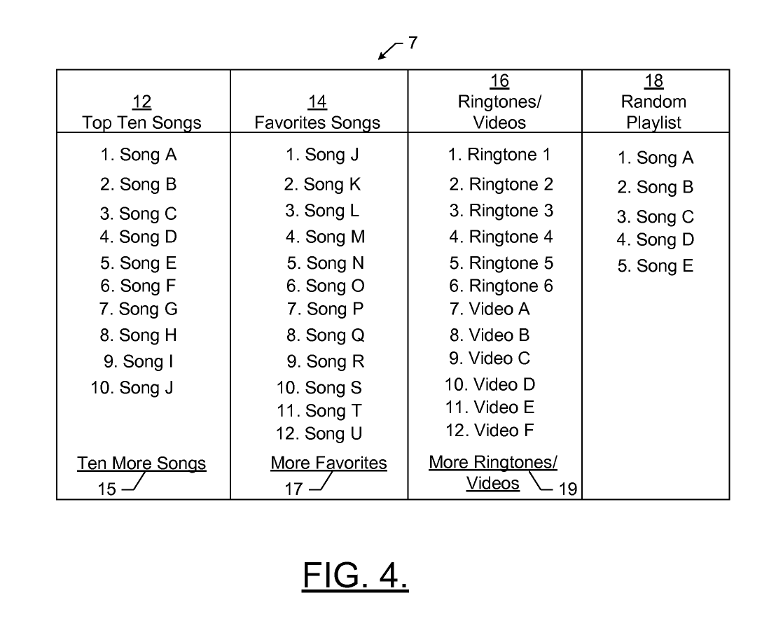

In an exemplary embodiment, the ringtone database 83 may store the top ten songs played by the apparatus 50, the favorite songs of a user of the apparatus 50, one or more ringtones and videos as well as a random playlist of songs and this data may be arranged in a list (e.g., table 7 of FIG. 4) or table that is stored in database 83. Additionally, the memory 76 may store a contact list (e.g., phonebook) including one or more communication identifiers (e.g., phone numbers, email addresses, screen names, etc.) associated with one or more contacts and one or more groups of contacts.

The processor 70 may be embodied in a number of different ways. For example, the processor 70 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 70 may be configured to execute instructions as well as algorithms stored in the memory device 76 or otherwise accessible to the processor 70. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70, which may otherwise be general purpose processing elements or other functionally configurable circuitry if not for the specific configuration provided by the instructions, to perform the algorithms and operations described herein. However, in some cases, the processor 70 may be a processor of a specific device (e.g., a mobile terminal) adapted for employing embodiments of the invention by further configuration of the processor 70 by instructions for performing the algorithms and operations described herein. The processor 70 may transmit and/or receive instructions or commands from alert generation module 78. These instructions or commands may include data indicating that an incoming call(s) or message(s) is being received by the apparatus 50, as detected by the processor 70 and/or the alert generation module 78, and may specify that a corresponding sound is to be played via speakers 87 to notify a user of the apparatus 50 of the call(s) or message(s). Additionally, these instructions or commands may include data specifying that corresponding video data (e.g., a movie, music video, video clip, etc.) is to be rendered or played via media device 65 in response to detection by the processor 70 and/or the alert generation module 78 of an incoming call(s) or message(s). In this regard, the media device 65 may instruct the display 85 to show the video data and may instruct the at least one of the speakers 87 to play or output associated audio data (e.g., audio associated with a movie, music video, video clip, etc.).

In an exemplary embodiment, the processor 70 may be configured to operate a connectivity program, such as a conventional Web browser. The connectivity program may then enable the apparatus 50 to transmit and receive Web content, such as location-based content, according to a Wireless Application Protocol (WAP), for example. The processor 70 may also be in communication with the display 85 and may instruct the display to illustrate any suitable information, data, content (e.g., media content) or the like.

The media device 65 may be any means such as a device or circuitry embodied in either hardware, software, or a combination of hardware and software capable of playing or rendering media content such as, for example, text data, audio data, images, photographs, animations, video data and any other suitable data. In this regard, the media device 65 may instruct the speakers 87 to play audio data and may instruct the display 85 to show video, animations, images, photographs or any other suitable data. It should be pointed out that the media device 65 may play media content in one or more playlists, libraries, galleries, collections or the like that may be stored in memory device 76 and the media device 65 may, but need not, play or render the media data in the ringtone database 83 of the memory device 76.

In an exemplary embodiment, the media device 65 may communicate with the alert generation module 78 and may, but need not, receive an instruction(s) or command(s) from the alert generation module 78 to render or play media content as a ringtone when an incoming call or message is received by the apparatus 50.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. The communication interface 74 may receive and/or transmit data via one or more communication channels. Additionally, in some embodiments the communication interface 74 may include a communication modem and/or hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, pointing device (e.g., stylus, pen, etc.) a joystick, a display, a touch screen, a microphone, a speaker, or other input/output mechanisms. In an exemplary embodiment in which the apparatus is embodied as a server or some other network devices, the user interface 67 may be limited, remotely located, or eliminated.

It should be pointed out that the processor 70 may comprise user interface circuitry configured to control at least some functions of one or more elements of the user interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

In an exemplary embodiment, the processor 70 may be embodied as, include or otherwise control an alert generation module 78. The alert generation module 78 may be any means such as a device or circuitry operating in accordance with software or otherwise embodied in hardware or a combination of hardware and software (e.g., processor 70 or another processor (not shown) operating under software control, the processor 70 embodied as an ASIC or FPGA specifically configured to perform the operations described herein, or a combination thereof) thereby configuring the device or circuitry to perform the corresponding functions of the alert generation module 78 as described below. Thus, in examples in which software is employed, a device or circuitry (e.g., the processor 70 in one example) executing the software forms the structure associated with such means. In this regard, for example, the alert generation module 78 may be configured to provide, among other things, for the assigning of items of media data as a ringtone for one or more contacts or one or more groups of contacts. The contacts and the groups of contacts may be identified in a contact list stored in the memory 76 of the apparatus. However, it should be pointed out that the contacts may relate to unknown contacts and that the contacts of a group(s) may correspond to an unknown group that may not be identified in the contact list.

The alert signal generation module 78 may keep track and store data regarding the number of times that the apparatus 50 plays items of media data such as for example songs, ring tunes, video data, and any other suitable media data that is associated with audio. In order to count the number of times items of media data (e.g., songs) are played, the alert signal generation module 78 may count each time or instance in which data associated with the corresponding items of media data is executed, for example, by processor 70 or the media device 65. The items of media data may be part of an album, playlist, library, gallery or any other suitable collection, which may be stored in memory 76. It should be pointed out that a user of the apparatus may generate and customize the albums, playlists, galleries, etc. by utilizing the user interface 67.

Additionally, the alert generation module 78 may keep track and store data regarding the number of communications between one or more contacts and/or one or more contacts of a group(s) and the apparatus 50. The contacts and groups may be identified in a contact list (e.g., phonebook) of the apparatus 50 and may be associated with a communication identifier(s). Additionally or alternatively, the contacts and groups may relate to unknown contacts and unknown groups that are not identified in the contact list. The unknown contacts and unknown groups may be identified in a call log that may be stored in a memory (e.g., memory device 76) of the apparatus 50.

The alert generation module 78 may keep track and store data regarding the number of times that one or more contacts and/or one or more contacts of a group(s) calls or sends a message (also referred to herein as incoming call/message) to the apparatus 50. In this regard, when the alert generation module 78 detects a communication identifier (e.g., phone number, email address, screen name, etc.) associated with a contact (e.g., Jane Doe) or a contact(s) of a group, the alert generation module 78 may count the incoming call/message associated with the respective contact(s). As such, the alert generation module 78 may keep track of the number of times a contact(s) and/or group(s) calls or sends messages to the apparatus 50.

By using data associated with the number of times that the apparatus 50 plays items of media data and the number of times one or more contacts/groups call or send messages to the apparatus 50, the alert generation module 78 may assign corresponding items of media data as ringtones for respective contacts, as described more fully below.

It should be pointed out that the alert generation module 78 may count the number of times a contact(s) or a contact(s) of a group(s) calls or sends messages to the apparatus in determining the number of communications with the apparatus 50. However, it should be pointed out that in an exemplary embodiment the alert generation module 78 may also count the number of times that the apparatus 50 calls or sends messages (also referred to herein as outgoing calls/messages) to a communication device of a corresponding contact(s) in determining the number of communications with the apparatus 50 without departing from the spirit and scope of the invention. For instance, the alert generation module 78 may assign a most played item of media data (e.g., a song) as a ringtone associated with a contact or a group that the apparatus communicates (e.g., via incoming and outgoing calls/messages) with the most or highest number or times.

It should be pointed out that when the alert generation module 78 determines, after a given time period (e.g., twenty four hours), that an item of media data is no longer the most played item of media data on the apparatus 50, the alert generation module 78 may dynamically reassign a ringtone to the contact or group that communicates (e.g., via incoming calls/messages and/or outgoing calls/messages) with the apparatus 50 the most. For instance, consider a scenario in which the alert generation module 78 determined that an item of media data such as for example song A was the most played item of media data on the apparatus 50 on a given day. In this regard, the alert generation module may assign song A as a ringtone to a contact (e.g., contact A) that has communicated with the apparatus the most. Consider further that after a predetermined time period or interval (e.g., twenty four hours) that the alert generation module 78 determines that song B is the most played item of media data and that Contact A remains the contact that communicated with apparatus 50 the most. In this regard, the alert generation module 78 may dynamically reassign the ringtone associated with Contact A such that song B is designated as the ringtone associated with Contact A.

It should be pointed out that upon the expiration of the predetermined time period or interval, the alert generation module 78 may determine the most played items of media data and the contact(s) or group(s) of contacts that has communicated with the apparatus 50 the most times. The predetermined time period (e.g., twenty four hours) may be set by a user utilizing the user interface 67 of the apparatus 50. For instance, the user may utilize a pointing device (e.g., stylus) or the like of the user interface 67 to select the predetermined time period from a menu, folder, button or the like containing options for predetermined time periods (e.g., 12 hrs., 24 hrs., 36 hrs., 48 hrs., etc.). Additionally or alternatively, the user may utilize a keyboard or keypad of the user interface 67 to specify a time period or interval for the predetermined time period. For instance, the user may utilize the keypad to type a time period such as for example 12 hrs. into a field designating the predetermined time period as 12 hrs.

In an alternative exemplary embodiment, the alert generation module 78 may randomly select items of media data (e.g., songs, video data (e.g. music videos, etc.)) stored in a memory (e.g., memory device 76) of the apparatus 50 and assign the selected items of media data as ringtones associated with contacts or groups of contacts. In this regard, the alert generation module 78 may randomly select items of media data which may, but need not, be in a playlist and the alert generation module 78 may assign the randomly selected items of media data according to the order of the number of times that a contact(s) or contact(s) of a group(s) communicates with the apparatus 50.

For instance, the first item of media data (e.g., a song) that is randomly selected by the alert generation module 78 may be assigned as a ringtone associated with a contact or a contact of a group that communicates with the apparatus 50 a highest or most number of times. The second item of media data (e.g., music video) that is randomly selected by the alert generation module 78 may be assigned as a ringtone associated with a contact or a contact of a group that communicates with the apparatus 50 a second highest number of times. The alert generation module 78 may continue to assign randomly selected items of media data as ringtones associated with one or more contacts or contacts of a group in this manner until all the contacts of a contact list or call log(e.g., a log on unknown contacts that may not be identified in the contact list) are associated with a ringtone.

It should be pointed out that if there are fewer items of media data to select from than there are contacts, the alert generation module 78 may randomly choose a previously selected item of media data to assign as a ringtone for a contact(s) or a contact(s) of a group(s) after the alert generation module 78 determines that all of the items of media data designated for random selection have been previously assigned as a ringtone associated with a contact(s) or group(s).

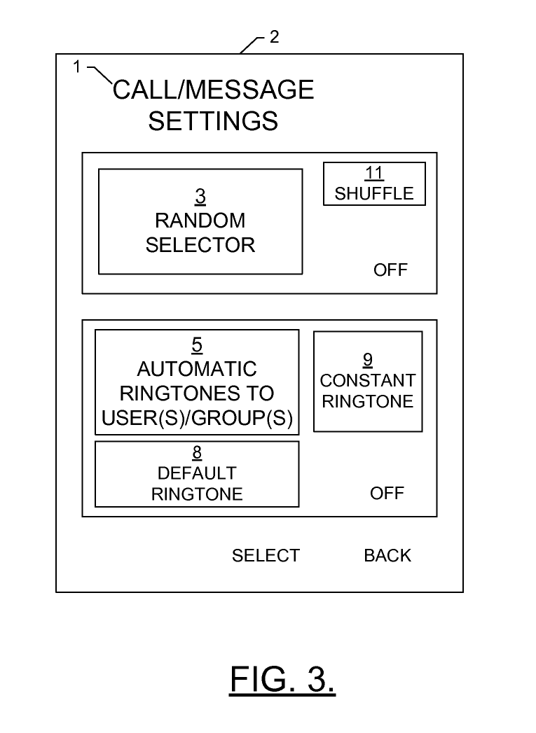

Referring now to FIG. 3, an exemplary embodiment of a user setting according to an exemplary embodiment is provided. The user setting may be any means embodied in software and/or hardware for enabling a user of the apparatus 50 to make or select changes to the call/message settings 1 of the apparatus 50. The user setting 2 may be accessible via a soft key or button of user interface 67 (or alternatively a soft key or button of a keypad for example) and is capable of being activated or invoked upon depression of this soft key or button. Depressing a soft key which allows the user setting 2 to be displayed on display 85. The user of the apparatus 50 may then use a stylus or the like of the user interface 67 to navigate the user setting 2 and select the random selector 3, automatic ringtones to user(s)/group(s) 5, default ringtone 8, constant ringtone 9 and shuffle 11 features of user setting 2.

Selection of the automatic ringtone to user(s)/group(s) 5 feature may allow the alert generation module 78 to select items of media data (e.g., songs, video data, predefined ring tunes, etc.) from one or more lists (e.g., play lists) as ringtones associated with contacts or groups of contacts. The lists may be ordered from 1 to N, where N is a natural number. In this regard, the alert generation module 78 may assign a corresponding item of media data having the highest number as a ringtone for a contact(s) or a group(s) that communicates with the apparatus 50 a highest or most number of times.

The lists may be generated by the alert generation module 78 and the lists may, but need not, correspond to the most played items of media data, the most purchased items of media data, the top rated items of media data, the worst rated items of media data or any other suitable list of items of media data. It should be pointed out in an exemplary embodiment, data associated with the most purchased items of media data, the top rated items of media data and the worst rated items of media data may be provided to the alert generation module 78 by a network entity or device (e.g., third communication device 25).

Additionally or alternatively, it should be pointed out that the user of the apparatus 50 may generate or customize his or her own lists of ordered items of media data that are may utilized by the alert generation module 78 to assign ringtones to contacts and groups of contacts based on the number of times that the contacts or groups communicate with the apparatus 50. In an exemplary embodiment, the alert generation module 78 may, upon selection of an option by a user, send the lists to other communication devices (e.g., second communication device 20) via network 30 so that the lists may be shared by with other users.

It should also be pointed out that the selection of the automatic ringtones to users/groups 5 feature of the user setting 2 may allow the alert generation module 78 to dynamically update a respective list of media items (e.g., list of most played items of media data) after a predetermined time period or interval. For instance, upon expiration of the predetermined time period, the alert generation module 78 may determine whether an item of media data previously assigned a highest number (e.g., “1”) designated as the most played item of media data in the list remains the most played item of media data by the apparatus 50. When the alert generation module 78 determines that an item of media data is the most played item of media data by apparatus 50 after the expiration of the predetermined time period (e.g., twenty four hours), the alert generation module 78 may allow the item of media data to remain the highest in the list and assigned as the ringtone for a contact or group that communicates with the apparatus 50 the most times.

On the other hand, when the alert generation module 78 determines that another item of media data in the list is the most played item of media data after the expiration of the predetermined time period, the alert generation module 78 may reorganize the list so that this item of media data is identified as the highest in the list. In this regard, the alert generation module 78 may assign the item of media data that is newly determined as the most played item of media data as a ringtone associated with the contact or group that communicates with the apparatus 50 the most. In this regard, the media items in the list may be refreshed and rearranged by the alert generation module upon the expiration of the predetermined time period.

Selection of the default ringtone 8 feature may allow the alert generation module 78 to assign an item of media data (e.g., song) as a ringtone for every incoming call/message received by the apparatus 50 from a contact(s) or group(s). In an exemplary embodiment, the item of media data may be selected by a user via user interface 67. It should be pointed out that the item of media data assigned as the ringtone may be automatically changed by the alert generation module 78 based on an item of media data that is most played by apparatus 50 during a time period. In this regarding the alert generation module 78 may replace the previously assigned item of media data with the most played item of media data such that the most played item of media data is assigned as the ringtone.

Selection of the constant ringtone 9 feature may allow the alert generation module 78 to assign the highest numbered item of media data in a list as a ringtone associated with a contact or group that communicates with the apparatus 50 the most. Additionally, the constant ringtone feature may allow the alert generation module 78 to assign the second highest numbered item of media data in the list as a ringtone associated with a contact or group that communicates with the apparatus 50 a second highest number of times so on and so forth in the manner analogous to that described above with respect to the automatic ringtones to user(s)/group(s) 5 feature, except that the alert generation module 78 may not refresh or rearrange the list after a predetermined time period (e.g., twenty four hours). (It should be pointed out that the predetermined time period may be a time interval from a previous assignment of the items of media data, by the alert generation module 78, as ringtones for one or more contacts or one or more groups.) Additionally, the alert generation module 78 may not determine the number of times one or more contacts or groups communicate with the apparatus 50 after a predetermined time period when the constant ringtone 9 feature is selected. As such, the alert generation module 78 may assign items of media data in the list as ringtones associated with one or more contacts or groups once when a user selects the constant ringtone feature 9.

Selection of the random selector 3 feature may enable the alert generation module 78 to randomly select items of media data from a list (e.g., playlist) that may be assigned by the alert generation module 78 as ringtones for one or more contacts or one more groups of contacts. For instance, the first item of media data randomly selected by the alert generation module 78 may be assigned as a ringtone associated with the contact or group of contacts that communicates with the apparatus 50 the most times. The second item of media data randomly selected by the alert generation module 78 may be assigned as a ringtone to the contact or group of contacts that communicates with the apparatus 50 a second highest number of times, so on a so forth. When the alert generation module 78 determines that there are fewer items of media data for random selection than there are contacts or groups, the alert generation module 78 may assign a previously randomly selected item of media data to a contact or group after all items of media data in list have been assigned as ringtones associated with contacts.

It should also be pointed out that selection of the shuffle 11 feature may allow the alert generation module 78 to shuffle or rearrange a list of items of media data and play a different item of media data upon receipt of each incoming call/message. In an exemplary embodiment a shuffled item of media data may not be played twice until all of the items of media data in the list are played once.

In an alternative exemplary embodiment selection of the shuffle feature may allow the alert generation module 78 to shuffle a list of media items and assign each item of media data as a ringtone associated with one or more contacts or groups of contacts based on the number of times that the contacts or groups communicate with the apparatus 50. In this manner, the first item of media data shuffled in the list may be assigned to the contact or group of contacts that communicates with the apparatus 50 the most number of times. The second item of media data shuffled in the list may be assigned to the contact(s) or group(s) of contacts that communicates with the apparatus 50 a second highest number of times, so on and so forth until the alert generation module 78 assigns every shuffled item of media data in the list as a ringtone associated with a contact(s) or group(s). Once every shuffled item of media data is assigned as a ringtone, the alert generation module 78 may shuffle the items of media data in the list again and assign respective items of media data as ringtones for contacts or groups that have not previously been assigned a ringtone.

Referring now to FIG. 4, an exemplary embodiment of items of media data that may be assigned as ringtones for one or more contacts or groups is provided. As shown in FIG. 4, the items of media data may be arranged in a table 7 (also referred to herein as list 7) having lists 12, 14, 16 and 18. In the exemplary embodiment of FIG. 4, the alert generation module 78 may generate the list 12 based on the top ten songs that are played the most number of times by the apparatus 50. In this manner, the alert generation module 78 may utilize the list 12 to assign Song A as a ringtone associated with a contact or group that communicates with the apparatus 50 a most or highest number of times. In like manner, the alert generation module 78 may utilize the list 12 to assign Song B as a ringtone associated with a contact or group that communicates with the apparatus 50 a second highest number of times, so on and so forth. By selecting a link 15, a user may view the next top ten songs played by the apparatus 50.

The list of favorites 14 may be generated by a user via the user interface 67 by designating the user's favorite songs in an ordered manner. The songs in the list of favorites 14 may be assigned by the alert generation module 78 as ringtones associated with one or more contacts or groups based on the number of times that the contacts or groups communicate with the apparatus 50 in the manner described above. The user may access more favorites by selecting the link 17.

As shown in FIG. 4, the list of ringtones/videos 16 may include one or more predefined ringtones (also referred to herein as ring tunes) as well as videos. The list of ringtones/videos may be generated by a user utilizing user interface 67. Alternatively, the list of ringtones/videos may be generated by a network entity or device (e.g., communication device 25) and provided to the alert generation module 78. In this regard, the alert generation module 78 may assign the predefined ring tunes and videos as ringtones associated with contacts or groups based on the number of times the contacts or groups communicate with the apparatus 50. For instance, the highest ordered item of media data (e.g., Ringtone 1) in the ringtones/videos list 16 may be assigned by the alert generation module 78 as a ringtone associated with the contact(s) or group(s) that communicates with the apparatus 50 the most, so on and so forth.

It should be pointed out that when the video of the list 16 is assigned as a ringtone for a corresponding contact or group that the alert generation module 78 may instruct the media device 65 to play the corresponding video data and may instruct the speakers 87 to play the audio data associated with the video data in response to receipt of an incoming call/message from the contact or group. A user of apparatus 50 may access more ringtones/videos by selecting the link 19.

The random list 18 (also referred to herein as random playlist) may include an ordered list of media items (e.g., songs) that may be randomly selected by the alert generation module 78 and assigned as ringtones associated with one or more contacts or one or more groups. For instance, the alert generation module 78 assign the first randomly select song (e.g., Song 3) as a ringtone associated with a contact or group that communicates with the apparatus 50 the most, so on and so forth in a manner analogous to that described above.

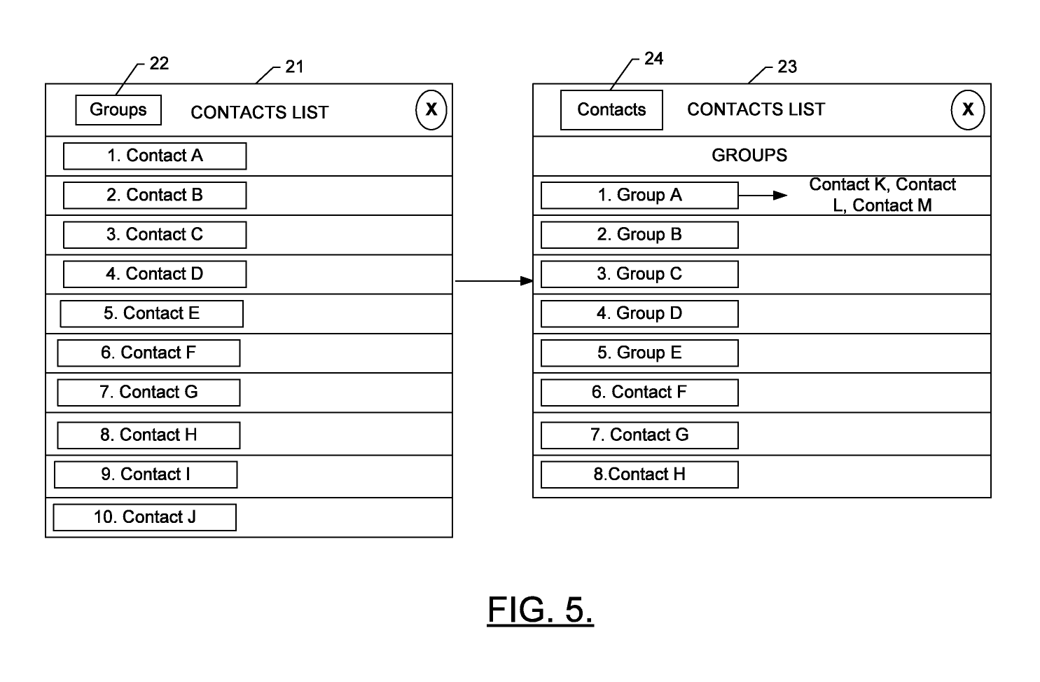

Referring now to FIG. 5, a diagram of ordered contacts and ordered groups in a contact list according to an exemplary embodiment is provided. As shown in FIG. 5, the alert generation module 78 may determine that Contact A communicated with apparatus 50 a most or highest number of times, that Contact B communicated with apparatus 50 a second most highest number of times and that Contact C communicated with apparatus 50 a third most highest number of times, so on and so forth. In this regard, the alert generation module 78 may assign an item of media data from a list such as, for example, top ten list 12 (see e.g., FIG. 4) with contacts of contacts list 21. For example, Song A of top ten list 12 may be assigned as a ringtone associated with Contact A of the contacts list 21. As another example, Song B of top ten list 17 may be assigned as a ringtone associated with Contact B.

Contact list 23 which shows a plurality of groups may be generated by selecting the groups tab 22 and the user may toggle back to contact list 21 by selecting contacts tab 24. It should be pointed out that each of the groups may be associated with one or more contacts. For example, Group A may be associated with Contacts J, K and L. As shown in contacts list 23, the alert generation module 78 may determine that Group A communicated with apparatus 50 a most or highest number of times, that Group B communicated with apparatus 50 a second highest number of times. Additionally, the alert generation module 78 may determine that Group C communicated with apparatus 50 a third highest number of times, so on and so forth. In this regard, the alert generation module 78 may assign items of media data of a list such as, for example, top ten list 12 as ringtones for groups. For instance, the alert generation module 78 may assign Song A of list 12 as a ringtone associated with Group A and may assign Song B of list 12 as a ringtone associated with Group B, so on and so forth. In this regard, when a contact (e.g., Contact J) of the group (e.g., Group A) calls or sends a message to the apparatus 50, the alert generation module 78 may instruct the speakers 87 to play audio associated with a ringtone (e.g., Song A) assigned to the group (e.g., Group A) to notify the user of the apparatus 50 of the call/message which may also be used to identify the contact(s) of the group.

As an example of an exemplary embodiment in which the alert generation module 78 may automatically update a list of items of media data based on the most often played items of media data consider a scenario in which a user listens to items of media data such as, for example, music for a given or predetermined time period (e.g., a week). In this regard, the alert generation module 78 may determine that a user listened to three songs during the time period and may count the number of times that the user listened to each song. As described above, the alert generation module 78 may count the number of times a user listens to items of media data based on determining that the corresponding data associated with the items of media data is being executed (for example by processor 70 or media device 65). In response to determining that the user utilized apparatus 50 to listen to three songs and determining the number of times the user listened to each song, the alert generation module 78 may generate a list with ordered items of media data, which are songs in this example. The list may specify in a sequence or order the songs that were determined, by the alert generation module 78, to be played the most number of times to the fewest or lowest number of times. An exemplary embodiment of a list that may be generated by alert generation module 78 according to this example is set forth below.

LIST OF ITEMS OF MEDIA DATA

| | |
|---|---|
| 1. Hardrock Song | Listened 100 Times |
| 2. Slow Song | Listened 98 Times |
| 3. Rave Song | Listened 80 Times |

As shown in the list above, the alert generation module 78 determined that the user listened to the Hardrock Song the most or highest number of times (e.g., 100 times) and as such the alert generation module 78 may arrange the Hardrock Song first in the list. The alert generation module 78 also determined that the Slow Song was listened by the user a second highest number of times (e.g., 98 times) and as such the alert generation module 78 may arrange the Slow Song second in the list. Additionally, the alert generation module 78 determined that the user listened to the Rave Song a third highest number of times (e.g., 80 times) and as such the alert generation module 78 may arrange the Rave Song third or last in the list since the user listened to the Rave Song the fewest number of times.

During a given time period (e.g. a week) the alert generation module 78 may also determine the number of times that the apparatus 50 communicated with one or more contacts or one or more groups of contacts. The alert generation module 78 may determine the number of times that the apparatus 50 communicated with one or more respective contacts or one or more groups of contacts by counting the received incoming calls/messages from the contact(s) or group(s) and/or the outgoing calls/messages sent from the apparatus 50 to a respective contact(s) or group(s).

In this regard, the alert generation module 78 may generate a list identifying the contacts or groups that communicated with the apparatus 50 during the time period and the list may include data specifying the number of times that the contact(s) or group(s) communicated with the apparatus 50. In this regard, the alert generation module 78 may generate the following list of contacts or groups according to this example.

LIST OF CONTACTS/GROUPS

| | |
|---|---|
| Dad | Called 22 Times |
| Mom | Called 20 Times |
| Wife | Called 18 Times |

As shown in the list of contacts/groups above, the alert generation module 78 determined that the user's Dad communicated with the apparatus 50 the most or highest number of times (e.g., called 22 times). In this regard, the alert generation module 78 may arrange contact information associated with Dad first in the list. Additionally, the alert generation module 78 determined that the user's Mom communicated with the apparatus 50 a second highest number of times (e.g., called 22 times) and as such the alert generation module 78 may arrange the contact information associated with Mom second in the list. The alert generation module 78 may also determine that the user's Wife communicated with the apparatus 50 the third highest (or fewest in this e.g.) number of times (e.g., called 18 times) and as such the alert generation module 78 may arrange the contact information associated with Wife third (e.g., last) in the list.

Now that the alert generation module 78 has determined the number of times items of media data (e.g., songs) are played by the apparatus 50 and the number of times that contacts or a group(s) of contacts have communicated with the apparatus 50 during a given time period (e.g., a week), the alert generation module 78 may assign the items of media data as ringtones associated with the contacts. The assignment, by the alert generation module 78, of the items of media data (e.g., songs) as ringtones associated with contacts may be based on the number of times that the alert generation module 78 determined that the items of media data (e.g., songs) were played and the number of times that the contacts or group(s) of contacts communicated with the apparatus 50.

For instance, the most played item of media data may be assigned, by the alert generation module 78, as a ringtone for a contact(s) or group(s) that communicated with the apparatus 50 the most. The second highest played item of media data may be assigned, by the alert generation module 78, as a ringtone for a contact(s) or group(s) that communicated with the apparatus 50 a second highest number of times and the third highest played item of media data may be assigned, by the alert generation module 78, as a ringtone for a contact(s) or group(s) that communicated with the apparatus 50 a third highest number of times. As such, when the alert generation module 78 assigns items of media data as ringtones associated contacts or groups of contacts there may be a correspondence between the number of times an item of media data is played and the number of times one or more contacts or one or more groups of contacts communicate with the apparatus 50. In this example, the alert generation module 78 may assign the items of media data (e.g., songs) as ringtones associated with contacts in the following manner.

Assignment of Items of Media Data as Ringtones

| | |
|---|---|
| Dad (communicated with | Assigned Hardrock Song as |
| apparatus 50 a most | Ringtone (played |
| or highest number of times) | most number of times) |
| Mom (communicated with | Assigned Slow Song as Ringtone (played |
| apparatus 50 a second | second most number of times) |
| highest number of times) | |
| Wife (communicated with | Assigned Rave Song as Ringtone (played |
| apparatus 50 a third | third most number of times) |
| highest number of times) | |

It should be pointed out that when the user selects a feature (e.g., constant ringtone 9 of FIG. 3) to keep the items of media data in an ordered list, generated by the alert generation module 78, constant the assignments of the items of media data as ringtones for corresponding contacts may remain unchanged even when a corresponding item of media data (e.g., Hardrock Song) is no longer the most played item of media data. As an alternative to selecting a feature to keep the items of media data and the assignments constant, the items of media data and assignments may remain constant in response to a user utilizing the user interface 67 to answer “No” to a prompt or question regarding whether the user would like to automatically update or refresh the assignments of ringtones for contacts or groups.

For purposes of illustration and not of limitation, consider a scenario in which the user may utilize the user interface 67 to select the automatic update or refresh feature by answering “Yes” to the prompt or question regarding whether the user would like to automatically update or refresh the assignments of ringtones for contacts or groups (or by selecting the automatic ringtones to user(s)/group(s) 5 feature). In this regard, the items of media data that may be assigned as ringtones for contacts or groups may be variables since previous assignments of ringtones may be changed. It should be pointed out that user may select a predetermined time period or interval in which the alert generation module 78 may perform the automatic update. Alternatively, the predetermined time period or interval may be a defined setting of the apparatus 50 that may, but need not, be unchanged by the user or the predetermined time period or interval may be provided to the apparatus 50 by a network entity (e.g., third communication device 25) or the like.

Upon the expiration of the predetermined time period or interval (e.g., twenty four hours) the alert generation module 78 may again determine the number of times that items of media data have been played by the apparatus or listened to by the user. Additionally, the alert generation module 78 may determine the number of times one or more contacts or one or more groups of contacts have communicated with the apparatus 50. In this example, presume that upon the expiration of the predetermined time period that the alert generation module 78 determined that there were no communications between the apparatus 50 and any contact or contact of a group(s). However, in this example consider that the alert generation module 78 determined that the apparatus 50 has now played or the user has listened to the Slow Song 110 times, the Rave Song 103 times while the Hardrock Song has not been played or listened to any more times since a pervious check. As such, the alert generation module 78 may determine that the count of the Hardrock Song remains at 100. In this regard, the alert generation module may refresh or update the “LIST OF ITEMS OF MEDIA DATA” as follows.

LIST OF ITEMS OF MEDIA DATA

| | |
|---|---|
| 1. Slow Song | Listened 110 Times |
| 2. Rave Song | Listened 103 Times |
| 3. Hardrock Song | Listened 100 Times |

As such, the alert generation module 78 may reassign the items of media data as ringtones for the contacts or groups such that the most played song, the Slow Song in this example, is assigned as ringtone for the contact that communicated with the apparatus 50 the most (e.g., Dad). The alert generation module 70 may assign the second most played song, the Rave Song in this example, as a ringtone for the contact (e.g., Mom) that communicated with the apparatus 50 the second highest number of times. Additionally, the alert generation module 78 may assign the third most played song, the Hardrock Song in this example, as a ringtone for the contact (e.g., wife) that communicated with the apparatus 50 the third highest number of times. As such, the alert generation module 78 may update the “Assignments of Items of Media Data as Ringtones” as follows.

Assignment of Items of Media Data as Ringtones

| | |
|---|---|
| Dad (communicated with apparatus | Assigned Slow Song as Ringtone |
| 50 a most or highest number | (played most number of times) |
| of times) | |
| Mom (communicated with apparatus | Assigned Rave Song as Ringtone |
| 50 a second highest number of times) | (played second most |
| | number of times) |
| Wife (communicated with apparatus | Assigned Hardrock Song as |
| 50 a third highest number of times) | Ringtone (played third most |
| | number of times) |

It should be pointed out the assignments of the items of media data as ringtones to contacts may be different if the alert generation module 78 determined upon expiration of the predetermined time period that the number of times the contacts communicated with the apparatus 50 changed. For instance, upon the expiration of the predetermined time period, if the alert generation module 78 determined that user's Mom called the apparatus 50 twenty five times (e.g., the most communications with apparatus 50), the alert generation module may assign the Slow Song as a ringtone for contact Mom.

It should also be pointed out that the alert generation module 78 may dynamically change the assignments of the items of media data as ringtones periodically upon the expiration of a time interval associated with the predetermined time period (e.g., twenty four hours).

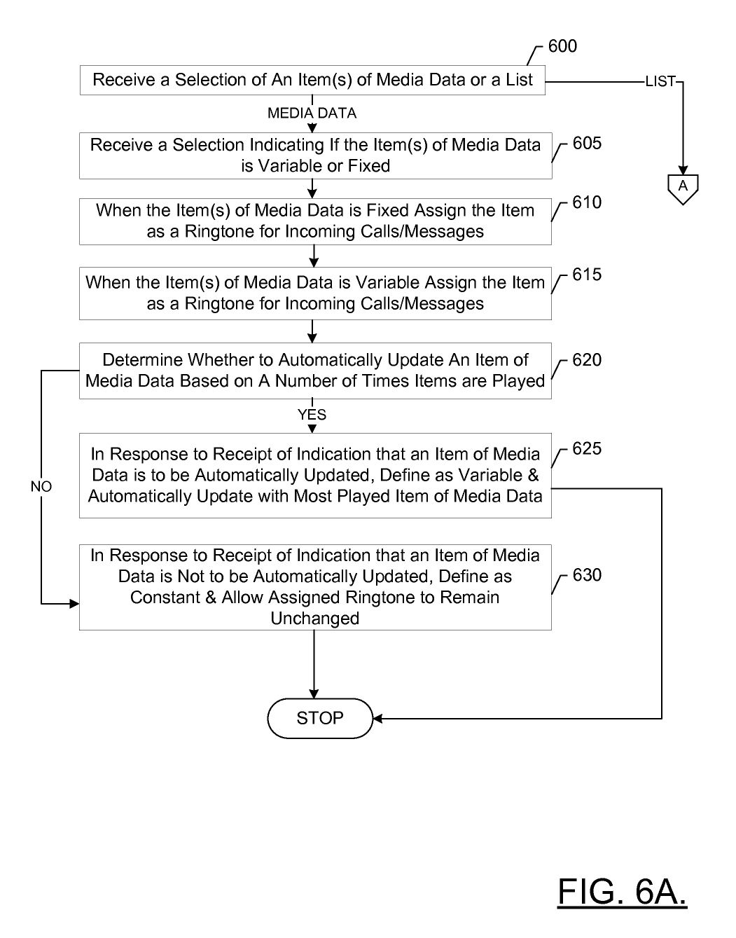

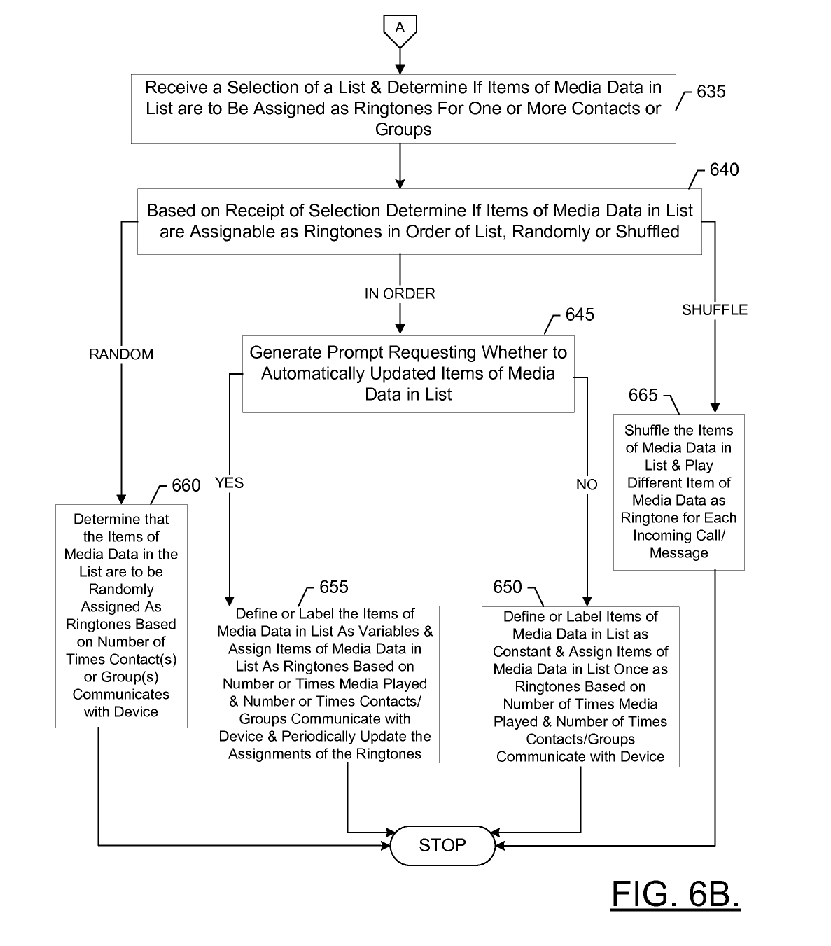

Referring now to FIGS. 6A & 6B, an exemplary method of a flowchart for assigning items of media data as ringtones for one or more contacts and/or one or more groups according to an exemplary embodiment is provided. At operation 600, an alert generation module 78 of a device such as, for example, apparatus 50 may receive a selection of at least one item of media data (e.g., a video clip (e.g., a music video)) or a list (e.g., playlist) identifying one or more items of media data. The selection of the item of media data and the list (e.g., top ten songs list 12) may be performed by a user utilizing a user interface (e.g., user interface 67). In an exemplary embodiment, the item of media data and the list may, but need not, be selected from a table or another list (e.g., table 7). At operation 605, the apparatus 50 may receive a selection indicating whether a selected item of media data is variable or fixed. At operation 610, when the alert generation module 78 determines that the item of media data is fixed based on the selection, the alert generation module 78 may assign the item of media data as a ringtone for incoming calls or messages received by a device (e.g., apparatus 50) from one or more contacts or one or more contacts of a group(s). It should be pointed out that when the item of media data is designated as fixed and is assigned as a ringtone for incoming calls and messages, the ringtone may not be automatically changed to correspond to an item of media data that is played the most by a device.

At operation 615, when the alert generation module 78 determines that the item of media data is variable based on the selection, the alert generation module 78 may assign the item of media data as a ringtone for incoming calls or messages received by a device from one or more contacts or one or more contacts of a group(s). Additionally, when the alert generation module 78 determines that item of media data is variable based on the selection, the alert generation module 78 may replace the selected item of media data that was assigned as a ringtone for incoming calls or messages associated with a contact(s) or a group(s) of one or more contacts with an item or media data (e.g., a song) that is played the most number of times on a device (e.g., apparatus 50) during a given time period (e.g., a week). The alert generation module 78 may determine the number of times an item of media data is played by determining the number of times data (e.g., Moving Picture Experts Group Phase 1 (MPEG-1) Audio Layer 3 (MP3) data, Waveform Audio File Format (WAV) data) associated with the respective item of media data is executed.

At operation 620, the alert generation module 78 may receive a selection regarding whether the item of media data that was determined to be played the most number of times by the device (e.g., apparatus 50) should be automatically updated or refreshed by the alert generation module 78 with another item of media data that is newly determined, by the alert generation module 78, to be played the most by the device. It should also be pointed out that the alert generation module 78 may receive the selection in response to a prompt associated with a question asking the user if he/she wishes to automatically update an item(s) of media data. Alternatively, the user may utilize a user interface (e.g., user interface 67) to select a feature (e.g., constant ringtone 9) to automatically update items of media data.

At operation 625, in response to the alert generation module 78 receiving a selection that an item of media data is to be automatically updated, or refreshed with another item of media data that is determined to be played the most by a device, the alert generation module 78 may define or label the item of media data as variable. Additionally, the alert generation module 78 may replace the item of media data (e.g., song A) that may currently be assigned as a ringtone for incoming calls/messages received by a device with the item of media data (e.g., song B) that is newly determined to be played the most by the device. In this regard, the item of media data that is newly determined to be played by the device (e.g., apparatus 50) the most number of times may be assigned, by the alert generation module 78, as the ringtone for incoming calls/messages received by the device. It should be pointed out that the determination of the alert generation module 78 as to whether there is item of media data that is played more often by a device than a previously selected item of media data that is assigned as a ringtone may occur after a predetermined time period or interval (e.g., twenty four hours).

At operation 630, in response to the alert generation module 78 receiving a selection that an item of media data is not to be automatically updated, or refreshed with another item of media data that is determined to be played the most by a device, the alert generation module 78 may label the item of media data as constant. In this regard, a currently selected item of media data that may be assigned, by the alert generation module, as a ringtone for incoming calls/messages received by a device (e.g., apparatus 50) may remain unchanged and may continue to be utilized as the ringtone for the incoming calls/messages.

At operation 635, in response to the alert generation module 78 receiving a selection of a list (e.g., a playlist) identifying one or more items of media data, the alert generation module 78 may determine that the items of media data in the list are to be assigned as ringtones for one or more contacts or one or more groups. At operation 640, the alert generation module 78 may determine, based on receipt of a selection, whether the items of media data in the list are to be assigned as ringtones for contacts or groups in the order or sequence that they are identified or arranged in the list, in a random manner, or in a manner in which the items of media data in the list are to be shuffled. The selection may generated by a user utilizing a user interface (e.g., user interface 67).

At operation 645, in response to determining that the items of media data are to be assigned as ringtones for one or more contacts or one or more groups in the order or sequence that they are identified and arranged in the list, the alert generation module 78 generate a prompt or question asking a user whether he/she wishes to automatically update the items of media data in the list with the items of media data that are determined to be most played by a device (e.g., apparatus 50) after a predetermined time period or interval. Additionally, the prompt or question may ask the user whether he/she would like to automatically update the number of times one or more contacts or one or more groups communicate with a device (e.g., apparatus 50) after a predetermined time period or interval. The prompt or question may be shown via a display (e.g., display 85). Alternatively, the user may be asked this question upon selection of automatic ringtones to user(s)/group(s) 5 feature.

At operation 650, in response to the alert generation module 78 receiving a selection that the user does not wish to automatically update the list of items of media data and does not wish to automatically update the number of times one or more contacts or one or more groups communicate with a device after a predetermined time period or interval, the alert generation module 78 may define or label the items of media data in the list as constant. Defining the items of media data in the list as constant may denote that the alert generation module should not automatically update the items of media data in the list or the number of times a contact(s) or group(s) communicates with device (e.g., apparatus 50) after the predetermined time period or interval. Defining the items of media data in the list as constant may also denote that once the items of media data in the list are assigned, by the alert generation module 78, as ringtones for corresponding contacts or groups, the items of media data in the list are not to be reassigned to different contacts or groups.

As described above, when the alert generation module 78 receiving a selection that the user does not wish to automatically update the list of items of media data and does not wish to automatically update the number of times contacts or groups communicate with a device, the alert generation module 78 may assign the items of media data of the list as ringtones for corresponding contacts or groups of contacts. For instance, the alert generation module 78 may assign the first item of media data identified in the list as a ringtone for a contact(s) or group(s) that communicated with a device a most or highest number of times. The first item of media data may be identified first in the list because the alert generation module 78 determined that the first item of media data was played the most by the device (e.g., apparatus 50). Similarly, the alert generation module 78 may assign the second item of media data identified in the list as a ringtone for a contact(s) or group(s) that communicated with a device a second highest number of times. In this regard, the second item of media data may be identified second in the list because the alert generation module 78 determined that the second item of media data was played the second highest number of times by the device. The alert generation module 878 may assign all of the items of data in the list once as ringtones to corresponding contacts or groups of contacts in a similar manner.

At operation 655, in response to the alert generation module 78 receiving a selection that the user wishes to automatically update the list of items of media data and wishes to automatically update the number of times one or more contacts or one or more groups communicate with a device, after a predetermined time period or interval, the alert generation module 78 may define or label the items of media data in the list as variable. Defining the items of media data in the list as variable may denote that the alert generation module 78 is to automatically update the items of media data in the list and the number of times a contact(s) or group(s) communicates with a device (e.g., apparatus 50) after the predetermined time period or interval. Defining the items of media data in the list as variable may also denote that once the items of media data in the list are assigned, by the alert generation module 78, as ringtones for corresponding contacts or groups, the items of media data in the list may be reassigned to different contacts or groups based in part on an updated number of times that the items of media data are played by a device (e.g., apparatus 50) and an updated number of times that a contact(s) or group(s) of contacts communicate with a device, after a predetermined time period or interval.

With respect to operation 655, it should be pointed out that the alert generation module 78 may assign the most played item of media data which may be identified first in a list with a contact or group that communicated with a device a most or highest number of times. The alert generation module 78 may also assign the second highest played item of media data, which may be identified second in the list, with a contact or group of contacts that communicated with a device a second highest number of times. The alert generation module 78 may continue to assign the items of media data as ringtones for contacts and groups in this manner until all the items of media data of the list are assigned as ringtones for a corresponding contact(s) or group(s). Since the alert generation module 78 may receive a selection to automatically update the list of items of media data based on determining the number of times items of media data are played on a device and to automatically update the number of times a contact or group communicates with a device, the may alert generation module 78 may reassign items of media content as ringtones for different contacts or groups of contacts, in a manner analogous to that described above.

At operation 660, the alert generation module 78 may determine that the items of media data in the list are to be randomly assigned as ringtones associated with one or more contacts or one or more groups of contacts. The alert generation module 78 may determine that the items of media data in the list are to be randomly assigned based on receipt of a selection. The selection may be made by a user utilizing a user interface (e.g., user interface 67). In this regard, the alert generation module 78 may randomly select an item of media data from the list (e.g., random playlist 18) and the first randomly selected item of media data (e.g., Song B of random playlist 18) may be assigned as a ringtone for a contact or group of contacts that communicated with a device (e.g., apparatus 50) a most or highest number of times, as determined by the alert generation module 78. As another example, the alert generation module may randomly select another item of media data from the list and the second randomly selected item of media data may be assigned as a ringtone for a contact(s) or group(s) of contacts that communicated with a device a second highest number of times, as determined by the alert generation module 78. In this regard, the alert generation module 78 may randomly select items of media data from a list until all of the contacts or groups of contacts are assigned a randomly selected item of media data as a ringtone. It should be pointed out that if there are more contacts or groups of contacts than there are items of media data in the list, the alert generation module 78 may randomly select an item of media data that was previously assigned as a ringtone for a contact(s) or group of contact(s) and may utilize this selected item of media data to assign a ringtone to another contact(s) or group(s) of contacts.

At operation 665, the alert generation module 78 may shuffle the items of media data in a list and may play a selected different item of media data as a ringtone for each incoming call or message that is received by a device (e.g., apparatus 50). In an exemplary embodiment, an item of media data previously played as a ringtone may not be played as a ringtone for a current incoming call/message until all of the items of media data have been assigned and used as a ringtone for an incoming call/message. In other words, after each of the items of media data of the list that are shuffled are played as ringtones, they may be used again as ringtones for other incoming calls/messages. In an alternative exemplary embodiment, the items of media data that are shuffled may be selected and assigned, by the alert generation module 78, as a ringtone for a contact or group of contacts based on the number of times the contact or group communicated with a device (e.g., apparatus 50).

It should be pointed out that FIGS. 6A & 6B are flowcharts of a system, method and computer program product according to exemplary embodiments of the invention. It will be understood that each block or step of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76) and executed by a processor (e.g., processor 70, alert generation module 78). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks or steps to be implemented. In some embodiments, the computer program instructions are stored in a computer-readable memory that can direct a computer or other programmable apparatus to function in a particular manner, such that the instructions stored in the computer-readable memory produce an article of manufacture including instructions which implement the function specified in the flowcharts blocks or steps. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts blocks or steps.

Accordingly, blocks or steps of the flowcharts support combinations of means for performing the specified functions and combinations of steps for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, an apparatus for performing the method of FIGS. 6A & 6B above may comprise a processor (e.g., the processor 70, alert generation module 78) configured to perform some or each of the operations (600-665) described above. The processor may, for example, be configured to perform the operations (600-665) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (600-665) may comprise, for example, the processor 70 (e.g., as means for performing any of the operations described above), the alert generation module 78 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining at least one item of media content, among a plurality of items of media content, that was played by a device a highest number of times during a predetermined time period;
assigning the item of media content as a ringtone associated with at least one contact that has communicated with the device; and
causing the data associated with the item of media content to be played in response to receipt of at least one communication from the contact.

2. The method of claim 1, further comprising:
assigning a new item of media content as the ringtone when a determination reveals that the device played the new item of media content the highest number of times.

3. The method of claim 1, further comprising:
determining a number of times that one or more contacts communicate with the device during the predetermined time period;
assigning the item of media content as a ringtone associated with a first contact that communicated with the device a highest number of times; and
causing the data associated with the item of media content to be played in response to receipt of a communication from the first contact,
wherein the contacts comprise one or more persons or one or more devices by which each of the persons communicate.

4. The method of claim 1, further comprising:
determining a number of times that each of the plurality of items of media content were played by the device during the predetermined time period;
automatically updating the number of times that each of the plurality of items of media content were played by the device upon the expiration of a predetermined time interval in response to receipt of a selection;
assigning a new item of media content as the ringtone when the determination reveals that the device played the new item of media content the highest number of times; and
causing the data associated with the new item of media content to be played in response to receipt of at least one other communication from the contact.

5. The method of claim 3, further comprising:
determining a number of times that each of the plurality of items of media content were played by the device during the predetermined time period;
arranging the items of media content in a sequence corresponding to the number of times that each item of media content was played by the device, the sequence is arranged, in part, based on a highest number of times that a respective item of media content was played to a lowest number of times that a respective item of media content was played; and
assigning the items of media content that were played the highest number of times to the lowest number of times as respective ringtones for corresponding contacts that communicated with the device a highest number of times to a lowest number of times.

6. The method of claim 5, wherein assigning the items of media content further comprises:
assigning an item of media content that was played the highest number of times as a ringtone for a second contact that communicated with the device the highest number of times;
assigning an item of media content that was played a second highest number of times as a ringtone for a third contact that communicated with the device a second highest number of times; and
repeating the assignments of items of media content as ringtones based on a correspondence between the number of times the items of media content were played by the device and the number of times each of the contacts communicated with the device until each of the items of media content are assigned as a ringtone for respective contacts.

7. The method of claim 6, further comprising:
automatically updating the number of times that the items of media content were played by the device upon the expiration of a predetermined time interval in response to receipt of a selection;
automatically updating the number of times that the contacts communicated with the device upon the expiration of the predetermined time interval in response to receipt of the selection;
rearranging the items of media content in the sequence corresponding to the updated number of times that each item of media content was played by the device upon the expiration of the predetermined time interval; and
reassigning the ringtone for the first contact to correspond to a different item of media content when the determination reveals that the different item of media content was played the highest number of times by the device upon the expiration of the predetermined time interval.

8. The method of claim 3, further comprising:
randomly selecting respective items of the media content; and
assigning each of the randomly selected items of media content as respective ringtones for corresponding contacts based on the number of times that each of the contacts communicate with the device, the first randomly selected item of media content is assigned as a ringtone for a second contact that communicated with the device the highest number of times.

9. The method of claim 3, further comprising:
shuffling or rearranging a sequence of the items of media content;
selecting different items of the shuffled media content as ringtones for each communication received by the device; and
causing data associated with at least one of the selected different items of media content to be played when the device receives a first communication.

10. An apparatus comprising:
at least one processor; and
at least one memory including computer program code, the at least one memory and the computer program code configured to, with the at least one processor, cause the apparatus to perform at least the following:
determine at least one item of media content, among a plurality of items of media content, that was played by the apparatus a highest number of times during a predetermined time period;
assign the item of media content as a ringtone associated with at least one contact that has communicated with the apparatus; and
cause the data associated with the item of media content to be played in response to receipt of at least one communication from the contact.

11. The apparatus of claim 10, wherein the at least one memory and the computer program code are further configured to, with the at least one processor, cause the apparatus to:
determine a number of times that one or more contacts communicate with the apparatus during the predetermined time period;
assign the item of media content as a ringtone associated with a first contact that communicated with the apparatus a highest number of times; and
cause the data associated with the item of media content to be played in response to receipt of a communication from the first contact,
wherein the contacts comprise one or more persons or one or more devices by which the persons communicate.

12. The apparatus of claim 10, wherein the at least one memory and the computer program code are further configured to, with the at least one processor, cause the apparatus to:
determine a number of times that each of the plurality of items of media content were played by the apparatus during the predetermined time period;
automatically update the number of times that each of the plurality of items of media content were played by the apparatus upon the expiration of a predetermined time interval in response to receipt of a selection;
assign a new item of media content as the ringtone when the determination reveals that the apparatus played the new item of media content the highest number of times; and
cause the data associated with the new item of media content to be played in response to receipt of at least one other communication from the contact.

13. The apparatus of claim 11, wherein the at least one memory and the computer program code are further configured to, with the at least one processor, cause the apparatus to:
determine a number of times that each of the plurality of items of media content were played by the apparatus during the predetermined time period;
arrange the items of media content in a sequence corresponding to the number of times that each item of media content was played by the apparatus, the sequence is arranged, in part, based on a highest number of times that a respective item of media content was played to a lowest number of times that a respective item of media content was played; and
assign the items of media content that were played the highest number of times to the lowest number of times as respective ringtones for corresponding contacts that communicated with the apparatus a highest number of times to a lowest number of times.

14. The apparatus of claim 13, wherein the at least one memory and the computer program code are further configured to, with the at least one processor, cause the apparatus to:
assign the items of media content by:
assigning an item of media content that was played the highest number of times as a ringtone for a second contact that communicated with the apparatus the highest number of times;
assigning an item of media content that was played a second highest number of times as a ringtone for a third contact that communicated with the apparatus a second highest number of times; and
repeating the assignments of items of media content as ringtones based on a correspondence between the number of times the items of media content were played by the apparatus and the number of times each of the contacts communicated with the apparatus until each of the items of media content are assigned as a ringtone for respective contacts.

15. The apparatus of claim 14, wherein the at least one memory and the computer program code are further configured to, with the at least one processor, cause the apparatus to:
automatically update the number of times that the items of media content were played by the apparatus upon the expiration of a predetermined time interval in response to receipt of a selection;
automatically update the number of times that the contacts communicated with the apparatus upon the expiration of the predetermined time interval in response to receipt of the selection;
rearrange the items of media content in the sequence corresponding to the updated number of times that each item of media content was played by the apparatus upon the expiration of the predetermined time interval; and
reassign the ringtone for the first contact to correspond to a different item of media content when the determination reveals that the different item of media content was played the highest number of times by the apparatus upon the expiration of the predetermined time interval.

16. The apparatus of claim 11, wherein the at least one memory and the computer program code are further configured to, with the at least one processor, cause the apparatus to:
randomly select respective items of the media content; and
assign each of the randomly selected items of media content as respective ringtones for corresponding contacts based on the number of times that each of the contacts communicate with the apparatus, the first randomly selected item of media content is assigned as a ringtone for a second contact that communicated with the apparatus the highest number of times.

17. The apparatus of claim 11, wherein the at least one memory and the computer program code are further configured to, with the at least one processor, cause the apparatus to:
shuffle or rearrange a sequence of the items of media content;
select different items of the shuffled media content as ringtones for each communication received by the apparatus; and
cause data associated with at least one of the selected different items of media content to be played when the apparatus receives a first communication.

18. A computer program product comprising at least one computer-readable storage medium having computer-executable program code instructions stored therein, the computer-executable program code instructions comprising:
program code instructions for determining at least one item of media content, among a plurality of items of media content, that was played by a device a highest number of times during a predetermined time period;
program code instructions for assigning the item of media content as a ringtone associated with at least one contact that has communicated with the device; and
program code instructions for causing the data associated with the item of media content to be played in response to receipt of at least one communication from the contact.

19. The computer program product of claim 18, further comprising:
program code instructions for determining a number of times that one or more contacts communicate with the device during the predetermined time period;
program code instructions for assigning the item of media content as a ringtone associated with a first contact that communicated with the device a highest number of times; and
program code instructions for causing the data associated with the item of media content to be played in response to receipt of a communication from the first contact,
wherein the contacts comprise one or more persons or one or more devices by which each of the persons communicate.

20. The computer program product of claim 18, further comprising:
program code instructions for determining a number of times that each of the plurality of items of media content were played by the device during the predetermined time period;
program code instructions for automatically updating the number of times that each of the plurality of items of media content were played by the device upon the expiration of a predetermined time interval in response to receipt of a selection;
program code instructions for assigning a new item of media content as the ringtone when the determination reveals that the device played the new item of media content a highest number of times; and
program code instructions for causing the data associated with the new item of media content to be played in response to receipt of at least one other communication from the contact.
